(19) United States
(12) Patent Application Publication
(10) Pub. No.: US 2006/0107238 A1
(43) Pub. Date: May 18, 2006

(54) Graphical language messaging

(76) Inventor: Steven K. Gold, Lexington, MA (US)

Correspondence Address: ROBERT PLOTKIN, PC, 91 MAIN STREET, SUITE 204, CONCORD, MA, 01742-2527, US

(21) Appl. No.: 11/340,387

(22) Filed: Jan. 26, 2006

(51) Int. Cl. G06F 9/00

(52) U.S. Cl. 715/864

(57) ABSTRACT

Techniques are disclosed for generating and transmitting a message from a first user (the “sender”) to a second user (the “recipient”) over a network. The message may, for example, include a sequence of graphical language elements selected by the sender using a first mobile communication device. The sender may select each of the graphical language elements from a graphical language by first selecting a category and then selecting a graphical symbol within the selected category. The resulting sequence of graphical language elements, also referred to as a “graphical language message,” may be displayed to the recipient by a second mobile communication device. The use of graphical language messages, rather than conventional messages consisting of text, may facilitate the processes of inputting, transmitting, and reading such messages. Furthermore, graphical language messages may be implemented in mobile communication devices using conventional, low-cost components.

### BACKGROUND

1. Field of the Invention

The present invention relates to electronic telecommunications and, more particularly, to techniques for generating, transmitting, and displaying human-readable messages over electronic networks.

2. Related Art

Mobile communication devices are becoming increasingly widespread. Examples of such devices include cellular telephones, personal digital assistants (PDAs), and wireless email devices. Increasing miniaturization of the components necessary for such devices, such as microprocessors and memory, is making it possible for such devices to become increasingly small without sacrificing functionality. For example, some cellular telephones available today provide functionality that was, until recently, only available in much larger laptop (or even desktop) computers.

Existing miniaturization is both a cause and effect of demand for miniaturization. The availability of mobile communication devices that are smaller than their predecessors creates appreciation for the benefits of miniaturization, thereby creating demand for even smaller devices. This demand drives the further miniaturization of such devices in a positive feedback loop that has yet to dampen.

There is a limit, however, to the extent to which certain physical components of a mobile communication device may be miniaturized without making it prohibitively difficult for the user to operate. For example, the display screen of such a device may be reduced in size only so much before its content becomes unreadable by the human eye. In response to this limitation, various techniques have been developed for making small display screens display information as efficiently as possible. For example, a web browser on a mobile communication device may display only critical information from a web page on the display screen, thereby reducing the need for the user to scroll through the web page. Furthermore, web pages may be specially designed to facilitate viewing on the small display screen of a mobile communication device.

Similarly, the input mechanism of a mobile communication device may only be reduced in size so much before it becomes prohibitively difficult for the user to operate. Keys, for example, must have a certain minimum size to be easily operable by human fingers. A variety of techniques, including both hardware- and software-based techniques, have been developed in attempts to maintain the usability of increasingly-small input mechanisms on mobile communication devices. Significant effort has been put into developing such techniques because the size of the input mechanism can be the limiting factor in the overall size of the device. In other words, if the input mechanism cannot be reduced in size, it may not be possible to further reduce the overall size of the device even if all other components of the device have been further miniaturized.

One common technique for reducing the size of the input mechanism on a mobile communication device is to abandon the QWERTY-style keyboard commonly found on laptop and desktop computers in favor of a mechanism having fewer keys. Some devices, for example, use a keypad having a 9- or 12-key configuration similar to that traditionally found on a touch-tone telephone. To enter alphanumeric input using such a keypad, it typically is necessary to make multiple keystrokes to input a single character. Such devices, in other words, trade off size against input speed. As a result, although such a keypad can be made relatively small, typing an email message using such a keypad can be a slow and tedious endeavor.

Another approach to increasing the efficiency with which input may be provided to a mobile communication device is to reduce the size of the message that the user needs to input to the device. Text messaging systems, for example, attempt to increase input efficiency by enabling users to input messages consisting of word abbreviations and other short sequences of characters, rather than entire words. Such shortened messages may be entered more efficiently by the user because they include fewer characters and require fewer keystrokes to produce.

Yet another approach to increasing the efficiency with which input may be provided to a mobile communication device is to expand the meaning associated with each unit of input provided by the user. For example, a user may use a small number of input gestures to capture a digital photograph using a cell phone camera and transmit that photograph to someone else. Because “one picture is worth a thousand words,” capturing and transmitting a digital photograph in this manner may enable the sending user to effectively input and transmit a message very efficiently in comparison to text-based messages.

These are merely a few examples of the kinds of techniques that have been developed in attempts to provide mobile communication devices with input mechanisms that are small, quick and easy to use, and inexpensive to manufacture. As indicated by the drawbacks of existing input mechanisms indicated above, what is needed are further improvements in input mechanisms for use in mobile communication devices.

### SUMMARY

Techniques are disclosed for generating and transmitting a message from a first user (the “sender”) to a second user (the “recipient”) over a network. A graphical language, including a plurality of graphical language elements, is defined. The message generated and transmitted by the sender may, for example, include a sequence of graphical language elements selected by the sender using a first mobile communication device. The sender may select each of the graphical language elements by first selecting a category and then selecting a graphical symbol within the selected category. The resulting sequence of graphical language elements, also referred to as a “graphical language message,” may be displayed to the recipient by a second mobile communication device. The use of graphical language messages, rather than conventional messages consisting of text, may facilitate the processes of inputting, transmitting, and reading such messages. Furthermore, graphical language messages may be implemented in mobile communication devices using conventional, low-cost components.

For example, one embodiment of the present invention is directed to a method for use by a wireless communication device. The method includes: (A) receiving, from a user of the device through an input means of the device, an indication of a first category; (B) receiving, from the user through the input means of the device, an indication of a first graphical language element in the first category; (C) receiving, from the user through the input means, an indication of a second category; (D) receiving, from the user through the input means, an indication of a second graphical language element in the second category; and (E) transmitting, from the device over a wireless network, a message including the first graphical language element followed by the second graphical language element, wherein the message includes a graphical language element representing a subject and a graphical language element representing an action.

Other features and advantages of various aspects and embodiments of the present invention will become apparent from the following description and from the claims.

### BRIEF DESCRIPTION OF THE DRAWINGS

FIG. 1 is a data flow diagram of a system for transmitting a message over a communications network according to one embodiment of the present invention;

FIG. 2 is a flowchart of a method that is performed by the system of FIG. 1 according to one embodiment of the present invention;

FIG. 3 is a diagram illustrating a set of categories and symbols supported by the communication devices of FIG. 1 according to one embodiment of the present invention;

FIG. 4 is an illustration of the communication device of FIG. 1 according to one embodiment of the present invention; and

FIGS. 5A-5C are illustrations of graphical language messages according to one embodiment of the present invention.

### DETAILED DESCRIPTION

Embodiments of the present invention provide techniques for generating and transmitting a message from a first user (the “sender”) to a second user (the “recipient”) over a network. A graphical language, including a plurality of graphical language elements, is defined. The message generated and transmitted by the sender may, for example, include a sequence of graphical language elements selected by the sender using a first mobile communication device. The sender may select each of the graphical language elements by first selecting a category and then selecting a graphical symbol within the selected category. The resulting sequence of graphical language elements, also referred to as a “graphical language message,” may be displayed to the recipient by a second mobile communication device. The use of graphical language messages, rather than conventional messages consisting of text, may facilitate the processes of inputting, transmitting, and reading such messages. Furthermore, graphical language messages may be implemented in mobile communication devices using conventional, low-cost components.

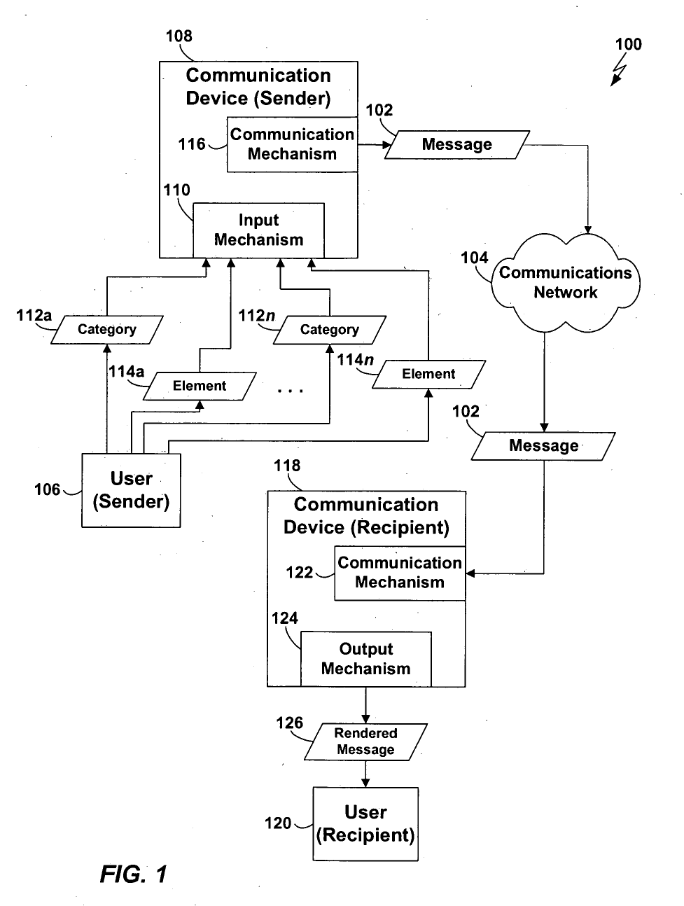

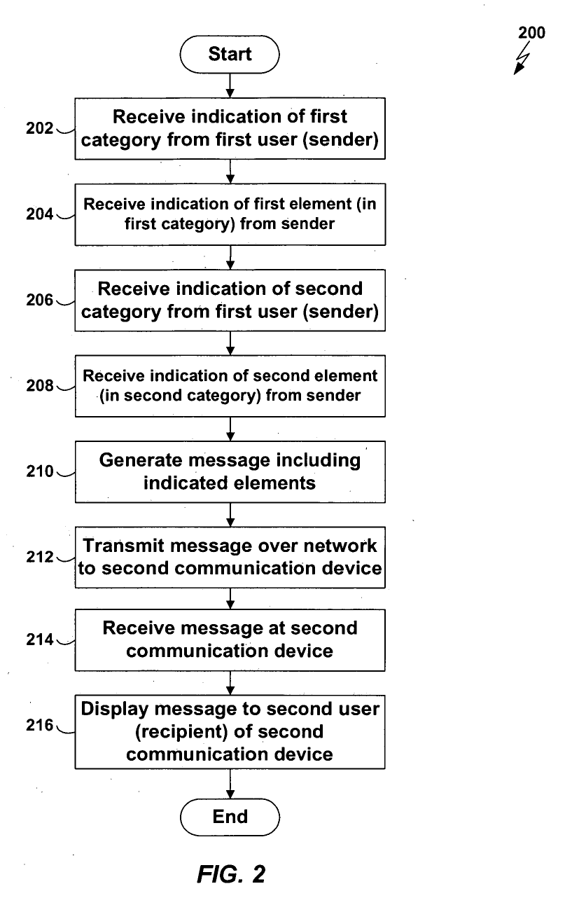

Various embodiments of the present invention, and advantages thereof, will now be described in more detail. Referring to FIG. 1, a dataflow diagram is shown of a system 100 for transmitting a message 102 over a communications network 104 according to one embodiment of the present invention. Referring to FIG. 2, a flowchart is shown of a method 200 that is performed by the system 100 of FIG. 1 according to one embodiment of the present invention.

A first user 106 (the “sender”) uses an input mechanism 110 of a first communication device 108 to generate a message 102. The communication device 108 may, for example, be a mobile communication device, such as a cellular telephone, PDA, or wireless email device, or a device custom-designed to perform the method 200 of FIG. 2.

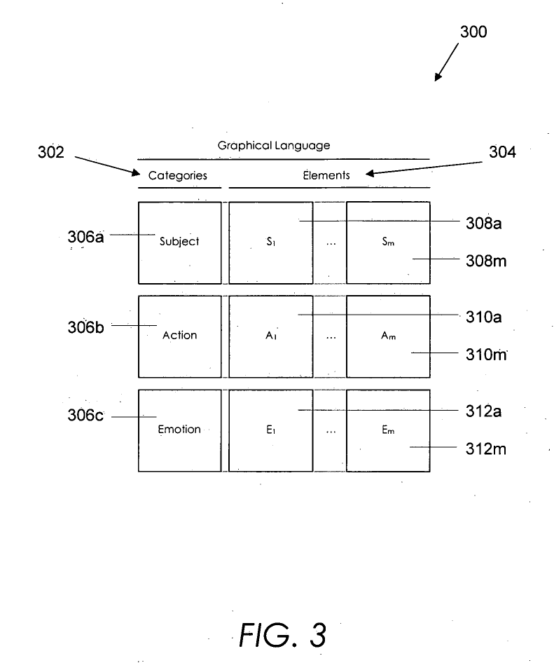

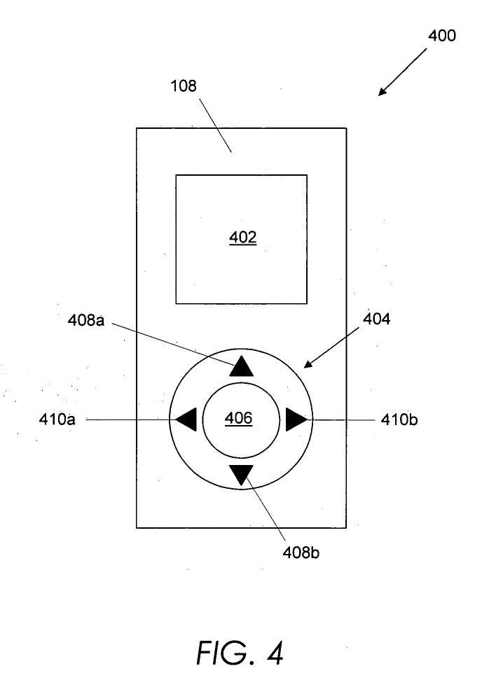

Referring to FIG. 4, a particular embodiment of the communication device 108 is shown. The device 108 includes a display screen 402, a rocker switch 404, and a select button 406. The rocker switch 404 is labeled with up 408a, down 408b, left 410a, and right 410b arrows, representing four positions of the switch 404. As will be described in more detail below with respect to FIG. 3, the sender 106 may use the switch 404 to scroll among a variety of input options and use the select button 406 to select the current input option as the input to be provided to the communication device 108.

The input mechanism 110 illustrated in FIG. 1 may, for example, be implemented using the rocker switch 404 and select button 406 illustrated in FIG. 4. The input mechanism 110 may further be considered to include components such as the display screen 402, which may display input while and/or after the sender 106 is generating such input.

The sender 106 may, for example, generate the message 102 as follows. In the example illustrated in FIGS. 1 and 2, the sender 106 uses the input mechanism 110 to select a first category 112a. As a result, the first communication device 108 receives an indication of the first category 112a from the sender 106 (FIG. 2, step 202).

The sender 106 may select the first category 112a in any of a variety of ways. For example, referring to FIG. 3, a diagram is shown illustrating a set 300 of categories 302 and elements 304 in a graphical language supported by the communication device 108 according to one embodiment of the present invention. In the embodiment illustrated in FIG. 3, there are three categories 302: “Subject” 306a, “Action” 306b, and “Emotion” 306c.

The sender 106 may, for example, select the first category 112a by using the up arrow 408a and down arrow 408b on the communication device 108 to scroll through the list of categories 302. The communication device 108 may, for example, initially display the name of the first category 306a (“Subject”), or a symbol representing the category, on the display screen 402. The sender 106 may cause the device 108 to display the name of the next category 306b (“Action”), or a symbol representing the category, by pressing the down arrow 408, and to display the previous category 306c (“Emotion”), or a symbol representing the category, by pressing the up arrow 408a. Examples of ways in which graphical language elements in these example categories 306a-c may be combined to form messages will be explained in more detail below.

Scrolling may be represented visually on the display screen 402 in any of a variety of ways, such as by displaying only the name or symbol representing the current category on the display screen 402, or by displaying the names or symbols representing multiple categories simultaneously but highlighting the name or symbol of the current category. Once the sender 106 has scrolled to the desired category, the sender 106 may select that category as input to the communication device 108 by pressing the select button 406.

Once the sender 106 has selected the first category 112a, the sender 106 may use the input mechanism 110 to select a first graphical language element 114a. As a result, the first communication device 108 receives an indication of the first element 114a from the sender 106 (FIG. 2, step 204).

The sender 106 may, for example, select the first element 114a by using the left arrow 410a and right arrow 410b (FIG. 4) on the communication device 108 to scroll through the list of elements within the category 112a selected in step 202. In the example illustrated in FIG. 3, elements 308a-m are in category 306a, elements 310a-m are in category 306b, and elements 312a-m are in category 306c, where m is the number of elements in each category. Although in the example illustrated in FIG. 3 each category has the same number of elements, this is not required, and different categories may have different numbers of elements.

The categories 306a-c define elements of different kinds. For example, all of the elements 308a-m in the “Subject” category 306a are elements representing subjects. Subject elements may represent people, places, or things (which may be tangible or intangible, such as a time or date). For example, element 308a might be an element representing the subject “I,” element 308b might be an element representing the subject “we,” element 308c might be an element representing the subject “you,” and so on. Each of the elements 308a-m has a particular graphical representation. For example, the “I” element 308a might be graphically represented as a simple representation of a person with a circle around it, whereas “we” might be shown as a simple representation of multiple people.

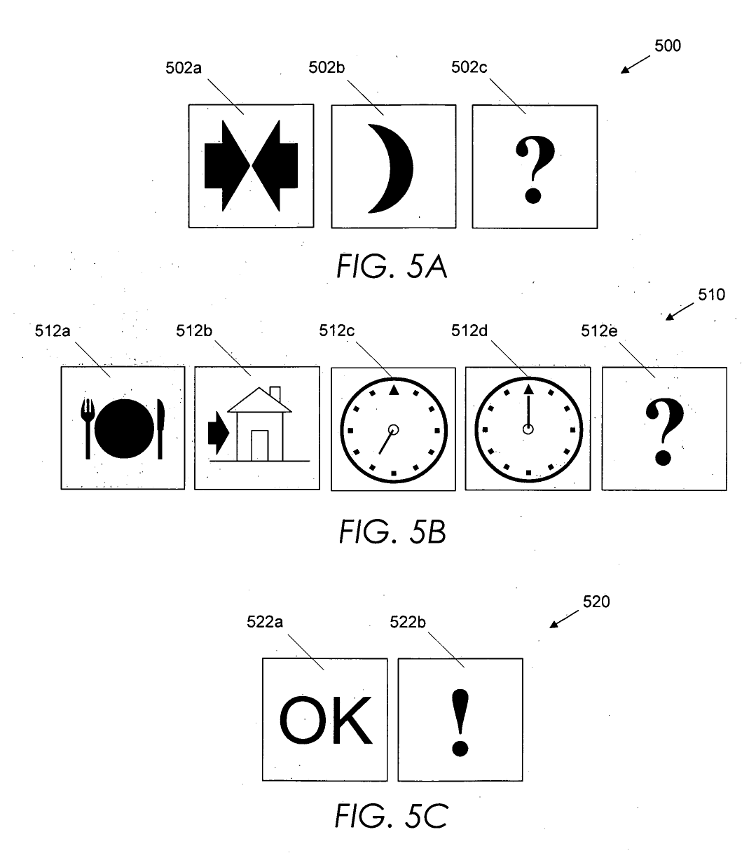

Similarly, all of the elements 310a-m in the “Action” category 306b are elements representing actions. For example, element 310a might be an element representing the action of meeting, and might be a graphical representation of two arrows pointing at each other (such as element 502a in FIG. 5A). Finally, all of the elements 314a-m in the “Punctuation and Emotion” category 306c are elements representing punctuations and emotions. Punctuation marks may, for example, be represented by graphical representations of themselves, while emotions may be represented, for example, by simple graphical representations of a face with a smile or frown.

The same element may appear in more than one category. For example, an “eye” element may represent both the subject “I” in the “Subject” category 306a and the action of seeing in the “Action” category 306b. As a result, an element may have a different meaning depending on the context in which it is used.

Having described the example categories 302 and elements 304 illustrated in FIG. 3, the discussion will now return to examples of techniques for generating the message 102. As an alternative to first displaying the categories 302 and then displaying the corresponding set of graphical language elements on the display screen 402, the communication device 108 may display a two-dimensional matrix of text and/or icons representing the categories 302 and elements 304, resembling the matrix illustrated in FIG. 3. The sender 106 may use the input mechanism 110 to move a cursor vertically within the matrix to select a category and horizontally within the matrix to select an element within the selected category. This is merely one example of a technique that may be used to facilitate generation of the message 102 by the sender 106. When using any technique for selecting elements, the display screen 402 may display the elements that have been selected so far, thereby keeping the sender 106 updated on the content of the message being composed.

Once the sender 106 has selected the first category 112a, the communication device 108 may facilitate selection of the first element 114a by displaying to the sender 106 only those elements corresponding to the first category. For example, if the sender 106 selects category 306a (“Subject”) as the first category 112a, the communication device 108 may display only elements 308a-m to the sender 106. The communication device 108 may, for example, initially display the first element 308a on the display screen 402 once the sender 106 has selected category 306a. The sender 106 may cause the device 108 to display the next element 308b (not shown) by pressing the right arrow 410b, and to display the previous element 308m by pressing the left arrow 410a. Once the sender 106 has scrolled to the desired element, the sender 106 may select that element as input to the communication device 108 by pressing the select button 406.

The sender 106 may provide indications of a second category 112b (step 206) and a second element 114b (step 208) in the same manner described above with respect to steps 202 and 204. The sender 106 may provide indications of any desired number n of categories and corresponding elements (represented in FIG. 1 by categories 112a-n and corresponding elements 114a-n). For ease of illustration, FIG. 2 only shows the reception by the communication device 108 of indications of two categories and corresponding graphical language elements.

Once the sender 106 has finished selecting categories 112a-n and corresponding elements 114a-n, the communication device 108 generates a message 102 including the selected elements 114a-n in the order selected (step 210). The communication device 108 includes a communications mechanism 116 that transmits the message 102 over communications network 104 to a second communication device 118 associated with a second user 120 (the “recipient”) (step 212). The sender 106 may indicate the end of the message 102 using any appropriate technique, such as by selecting a “send” command. Furthermore, the sender 106 may indicate the identity of the recipient 120 in any way, such as by selecting a telephone number, email address, or instant/text message handle of the recipient 120.

The receiving communication device 118 includes a communication mechanism 122 that receives the message 102 (step 214). The communication device 118 includes an output mechanism 124, such as a display screen, that renders the message 102 and displays the rendered message 126 to the recipient 120 (step 216). The rendered message 126 may, for example, display the sequence of graphical language elements selected by the sender 106. The receiving communication device 118 may, for example, be of the same type as the sending communication device 108 (e.g., of the type illustrated in FIG. 4).

Having generally described the operation of various embodiments of the present invention, further examples of embodiments of the present invention will now be described in more detail. Recall that in the example illustrated in FIG. 3, there are three categories 302: Subject 306a, Action 306b, and Punctuation and Emotion 306c. A message may be required to include graphical language elements in at least two different categories. For example, a message may be required to include at least one graphical language element in the Subject category 306a and at least one graphical language element in the Action category 306b. Such a requirement may, for example, require the message to begin with an element in the Subject category 306a followed immediately by an element in the Action category 306b.

Consider as an example the following exchange. The first user 106 asks of the second user 120, “Can we get together tonight?” Upon receiving this inquiry, the second user 120 responds by asking, “Why don't we meet at my house for dinner at 7:00 pm?” In response, the first user 106 says “OK!” These three messages, expressed in conventional written English, include subjects, actions, and punctuation and emotion. The elements 304 illustrated in the embodiment of FIG. 3 are grouped into categories 302 reflecting these three message elements.

Referring to FIGS. 5A-5C, examples are shown of graphical language messages 500, 510, and 520 that represent the above-mentioned exchange of three messages between the first user 106 and the second user 120 according to one embodiment of the present invention. Referring to FIG. 5A, in one embodiment, the inquiry “Can we get together tonight?” is represented by a message 500 including three graphical language elements 502a-c. The first element 502a is one of the elements 310a-m in the Action category 306b. More specifically, the first element 502a represents the action of “meeting.” The sender 106 may have selected the element 502a by using the input mechanism 110 to first select the Action category 306b and then to select the element 502a within that category 306b, using the techniques described above with respect to FIGS. 1 and 2.

The second element 502b is one of the elements 306a-m in the Subject category 306a. More specifically, the second element 502b represents the time “tonight.” The sender 106 may have selected the element 502b by using the input mechanism 110 to first select the Subject category 306a and then to select the element 502b within that category 306a, using the techniques described above with respect to FIGS. 1 and 2.

Finally, the third element 502c is one of the elements 314a-m in the Punctuation and Emotion category 306c. More specifically, the third element 502c represents a question mark. The sender 106 may have selected the element 502c by using the input mechanism 110 to first select the Punctuation/Emotion category 306c and then to select the element 502c within that category 306c, using the techniques described above with respect to FIGS. 1 and 2.

The sequence of three elements 502a-c illustrated in FIG. 5A therefore comprises a graphical language message expressing the question, “Can we get together tonight?” The communication device 108 may be configured to require that the elements 502a-c be specified in a particular order, or may provide the sender 106 with at least some freedom in specifying the order of the elements 502a-c. For example, if the elements 502a-c were reordered in the sequence 502b, 502a, 502c, or in the sequence 502c, 502a, 502b, the content of the message 500 would remain the same. The communication device 108 may allow the elements 502a-c to be arranged in these and other sequences.

Once the sender 106 has selected the elements 502a-c, the communication device 108 may generate and represent the message 102 in any of a variety of ways. For example, each of the elements 304 may be assigned a unique number or other code, and the sending device 108 may include a mapping of the elements 304 to corresponding codes. This and other techniques may be used to avoid the need to store and transmit graphical representations of the elements 502a-c in the message 102 transmitted over the network 104, thereby significantly reducing the bandwidth required to transmit the message 102. The receiving communication device 118 may include the graphical representations of the elements 502a-c and a mapping of the symbol codes in the message 102 to those graphical representations, thereby enabling the receiving communication device 118 to display the same message 500 (containing elements 502a-c) to the recipient 120. The selected categories 112a-n may or may not be included within the message 102.

Upon viewing the message 500 shown in FIG. 5A, the recipient 120 may generate a reply message 510 illustrated in FIG. 5B. The message 510 represents the reply “Why don't we meet at my house for dinner at 7:00 pm?” using elements 512a-e representing the action “eat” (element 512a), the subject “my house” (element 512b), the time (subject) “7:00” (elements 512c and 512d, where element 512c represents the hour and element 512d represents the minute within the hour), and a question (element 512e). The recipient 120 may select and provide the elements 512a-c as input to the communication device 118 using techniques similar to those described above with respect to the generation of the message 500 by the sender 106.

Upon viewing the message 510 shown in FIG. 5B, the sender 106 may generate a reply message 520 illustrated in FIG. 5C. The message 520 represents the reply “OK!” using elements 522a-b representing the word “OK” (element 522a), an exclamation point (element 522b). The sender 106 may select and provide the elements 522a-b as input to the communication device 108 using techniques similar to those described above with respect to the generation of the message 500. The first user 106 and second user 120 may continue to communicate with each other using such “graphical language messages” in the manner just described.

Among the advantages of the invention are one or more of the following. The use of graphical language messages, rather than conventional messages consisting solely or substantially of text, may facilitate the processes of inputting, transmitting, and reading such messages. For example, a graphical language message such as the message 500 illustrated in FIG. 5A may be input using more efficient input gestures (e.g., fewer button presses or keystrokes) than would otherwise be required to input the English-language equivalent of the message (e.g., “Can we get together tonight?”) using input mechanisms typically found on mobile communication devices. Graphical language messages may therefore be input quickly on mobile communication devices.

Furthermore, graphical language messages may be input in mobile communication devices using conventional, small, mechanically simple, low-cost components. The embodiment of the communication device 108 shown in FIG. 4, for example, requires only the rocker switch 404 and select button 406, eliminating the need for a conventional keypad or keyboard. The physical components necessary to the rocker switch 404 and select button 406 are widely available at low cost and require a relatively small surface area. Graphical language messages are therefore particularly useful in conjunction with mobile communication devices, because of the need to provide such devices with small, low-cost input mechanisms.

Graphical language messages may also be displayed on a smaller display screen than would be necessary to display the English-language equivalent of such messages. For example, the three elements 502a-c of the message 500 illustrated in FIG. 5A may be displayed at a readable size on a smaller display screen than would be necessary to display its English-language equivalent (“Can we get together tonight?”). This is yet another reason why graphical language messages are particularly useful in conjunction with mobile communication devices, which typically have small display screens.

Furthermore, even though graphical language messages may be rendered using graphical language elements, such messages may be transmitted using less bandwidth than would be required to transmit the graphical language elements as bitmaps or in another graphical form. As described above, the elements in a graphical language message may first be translated into corresponding codes before being transmitted over the communication network 104. For example, in a system with a total of 255 elements, each element may be represented as a single byte in the message 102 that is transmitted over the network. This effectively acts as a form of data compression that is particularly useful in conjunction with wireless communication devices that communicate at lower bandwidths than is typically available over wired networks.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The term “graphical language element” as used herein refers generally to any graphical representation of a word or other concept. A graphical language element may, for example, be a graphic, an icon, a picture, a photograph, an image of a word, a design, or a schematic. A graphical language element may be mapped to a particular word or discrete set of meanings. Although particular examples of graphical language elements are shown in FIGS. 5A-5C, these elements are merely examples and do not constitute limitations of the present invention.

The term “graphical language” as used herein refers to a finite set of graphical language elements that may be arranged and transmitted in any combination of ways to communicate a wide (potentially infinite) variety of meanings. Even though a graphical language includes a finite set of graphical language elements, the meanings attached to those elements, and combinations thereof, may vary from user to user.

The particular embodiment of the communication device 108 illustrated in FIG. 4 is merely an example and does not constitute a limitation of the present invention. The input mechanism 110 of the device 108 may, for example, be implemented using components other than the rocker switch 404 and select button 406. For example, in an another embodiment, a single key (such as an up arrow key) is used to scroll among categories, a single key (such as a right arrow key) is used to scroll among elements, and a single key (such as an enter key) is used to select the current element. Other input mechanisms may also be used to implement the techniques disclosed herein.

The input mechanism 110 may, for example, include conventional alphanumeric keys. The communication device 108 may enable the user 106 to use the input mechanism 110 to create new graphical language elements. For example, the communication device 108 may enable the user 106 to create elements containing text consisting of one or more alphanumeric or other characters (such as the elements 522a-b shown in FIG. 5C). Such a symbol may be created by receiving typed text from the user 106 and then generating a graphical representation of the typed text. An element may also be a graphical representation of a single character, such as the question mark element 502c shown in FIG. 5A. A message may include any combination of symbols, text, and other data.

The input mechanism 110 may include other components, such as a touch pad and/or touch screen. The input mechanism 110 may be voice activated and be capable of receiving speech input.

The input mechanism 110 need not use scrolling to select categories and/or elements in the manner described herein. For example, the input mechanism 110 may include buttons corresponding to each of the categories 306a-c. The user 106 may select one of the categories by pressing the corresponding button, thereby eliminating the need to scroll through the categories 306a-c. These are merely examples of input mechanisms and techniques that may be used to generate the message 102, and do not constitute limitations of the present invention.

The communication device 108 may, for example, provide functionality equivalent to a cellular telephone, personal digital assistant, laptop computer, or any combination thereof. The communication device 108 may be fixed rather than mobile.

The particular categories 302 and elements illustrated in FIG. 3 are merely examples and do not constitute limitations of the present invention. Any number of any categories may be used, and any number of any elements may be used. The categories and/or elements may, for example, be predefined and hard-wired into the communication devices 108 and 118. The users 106 and 120 may be allowed to add new categories and/or elements to those recognized by the devices 108 and 118 (such as by downloading new categories and/or elements over the communications network 104, by typing the names of new categories, or by drawing new elements).

The communications network 104 may be any kind of network, such as the public Internet or a private intranet. The communications network 104 is not limited to any particular physical medium and may, for example, be either wired or wireless in any combination. Intermediate devices in the network 104 may be responsible for relaying the message 102 from the sending communication device 108 to the receiving communication device 118.

The user 106 may be allowed to generate the message 102 using any desired combination of elements in any sequence. Alternatively, for example, the communication device 108 may impose limitations on the elements that may be chosen and on the sequence in which elements may be arranged in the message 102. For example, as mentioned above, the communication device 108 may require the message to begin with an element representing a subject, followed by an element representing an action.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

For example, the techniques disclosed herein may be implemented as software applications executing on the communication devices 108 and 118. Copies of a single application may be used to provide both sending and receiving functionality.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, Or other raster output device capable of producing color or gray scale pixels on paper, film, display screen, or other output medium.

What is claimed is:

1. A method for use by a wireless communication device, the method comprising:
(A) receiving, from a user of the device through an input means of the device, an indication of a first category;
(B) receiving, from the user through the input means of the device, an indication of a first graphical language element in the first category;
(C) receiving, from the user through the input means, an indication of a second category;
(D) receiving, from the user through the input means, an indication of a second graphical language element in the second category; and
(E) transmitting, from the device over a wireless network, a message including the first graphical language element and the second graphical language element, wherein the first category and the second category differ from each other.

2. The method of claim 1, wherein the first category is selected from a group consisting of a subject category and an action category.

3. The method of claim 2, wherein the first category includes graphical language elements representing subjects and wherein the second category includes graphical language elements representing actions.

4. The method of claim 2, wherein the first category includes graphical language elements representing actions and wherein the second category includes graphical language elements representing emotions.

5. The method of claim 1, further comprising:
(F) prior to (E), repeating (C) and (D) at least once to receive at least one additional category and at least one additional graphical language element from the user through the input means;
and wherein (E) comprises transmitting a message including the first graphical language element, followed by the second graphical language element, followed by the at least one additional graphical language element.

6. The method of claim 1, wherein (A) comprises receiving from the user a selection of the first category from among a plurality of categories.

7. The method of claim 5, wherein (A) comprises displaying at least some of the plurality of categories to the user before receiving the selection of the first category from the user.

8. The method of claim 1, wherein (B) comprises receiving from the user a selection of the first graphical language element from among a plurality of graphical language elements.

9. The method of claim 8, wherein (B) comprises displaying at least some of the plurality of graphical language elements to the user before receiving the selection of the first graphical language element from the user.

10. The method of claim 8, wherein the plurality of graphical language elements comprises a predetermined set of graphical language elements stored in the wireless communication device.

11. The method of claim 1, wherein the wireless communication device comprises a mobile telephone.

12. The method of claim 1, wherein the wireless communication device comprises a personal digital assistant.

13. The method of claim 1, wherein the wireless communication device comprises a portable computer.

14. The method of claim 1, wherein the message further includes text.

15. The method of claim 14, further comprising:
(F) before (E), receiving the text from the user through the wireless communication device.

16. The method of claim 1, wherein the input means comprises a keypad.

17. The method of claim 1, wherein the input means comprises directional means for selecting a direction and selection means for selecting an input.

18. The method of claim 1, wherein the input means comprises means for scrolling through a list of available inputs and means for selecting one of the available inputs.

19. The method of claim 1, wherein the input means comprises a touch pad.

20. The method of claim 1, wherein the input means comprises a touch screen.

21. The method of claim 1, wherein (A) comprises:
(A)(1) receiving from the user a first instruction to scroll through a list of a plurality of categories;
(A)(2) visually scrolling through the list of the plurality of categories in response to the first instruction to arrive at a current category; and
(A)(3) receiving, from the user, an instruction to select the current category as the first category.

22. The method of claim 21, wherein (B) comprises
(B)(B1) receiving from the user a second instruction to scroll through a list of a plurality of graphical language elements;
(B)(2) visually scrolling through the list of the plurality of graphical language elements in response to the second instruction to arrive at a current graphical language element;
(B)(3) receiving, from the user, an instruction to select the current graphical language element as the first graphical language element.

23. The method of claim 22, wherein (A)(2) comprises visually scrolling in a first direction, and wherein (B)(2) comprises visually scrolling in a second direction that is substantially orthogonal to the first direction.

24. An apparatus for use with a wireless communication device, the apparatus comprising:
first category input means for receiving, from a user of the device, an indication of a first category;
first element input means for receiving, from the user, an indication of a first graphical language element in the first category;
second category input means for receiving, from the user, an indication of a second category;
second element input means for receiving, from the user, an indication of a second graphical language element in the second category; and
transmission means for transmitting, from the device over a wireless network, a message including the first graphical language element and the second graphical language element, wherein the first category and the second category differ from each other.

25. The apparatus of claim 24, wherein the first category is selected from a group consisting of a subject category and an action category.

26. The apparatus of claim 25, wherein the first category includes graphical language elements representing subjects and wherein the second category includes graphical language elements representing actions.

27. The apparatus of claim 25, wherein the first category includes graphical language elements representing actions and wherein the second category includes graphical language elements representing emotions.

28. The apparatus of claim 24, wherein the first category input means comprises means for receiving from the user a selection of the first category from among a plurality of categories.

29. The apparatus of claim 24, wherein the first element input means comprises means for receiving from the user a selection of the first graphical language element from among a plurality of graphical language elements.

30. The apparatus of claim 24, wherein the first category input means comprises a keypad.

31. The apparatus of claim 24, wherein the first category input means comprises a touch pad.

32. The apparatus of claim 24, wherein the first category input means comprises a touch screen.

33. The apparatus of claim 24, wherein the first category input means comprises:
means for receiving from the user a first instruction to scroll through a list of a plurality of categories;
means for visually scrolling through the list of the plurality of categories in response to the first instruction to arrive at a current category; and
means for receiving, from the user, an instruction to select the current category as the first category.

34. A method for use in conjunction with a wireless communication device, the method comprising:
(A) providing, to the device through an input means of the wireless communication device, an indication of a first category;
(B) providing, to the device through the input means of the device, an indication of a first graphical language element in the first category;
(C) providing, to the device through the input means, an indication of a second category;
(D) providing, to the device through the input means, an indication of a second graphical language element; and
(E) instructing the device to transmit a message over a wireless network, the message including the first graphical language element and the second graphical language element, wherein the first category and the second category differ from each other.

35. The method of claim 34, wherein the first category is selected from a group consisting of a subject category and an action category.

36. The method of claim 35, wherein the first category includes graphical language elements representing subjects and wherein the second category includes graphical language elements representing actions.

37. The apparatus of claim 35, wherein the first category includes graphical language elements representing actions and wherein the second category includes graphical language elements representing emotions.

38. The method of claim 34, further comprising:
(F) prior to (E), repeating (C) and (D) at least once to provide at least one additional category and at least one additional graphical language element to the device through the input means;
and wherein (E) comprises instructing the device to transmit a message including the first graphical language element, followed by the second graphical language element, followed by the at least one additional graphical language element.

39. The method of claim 34, wherein (A) comprises providing to the device a selection of the first category from among a plurality of categories.

40. The method of claim 34, wherein (B) comprises providing to the device a selection of the first graphical language element from among a plurality of graphical language elements.

41. The method of claim 34, wherein the message further includes text.

42. The method of claim 34, wherein the input means comprises a keypad.

43. The method of claim 34, wherein the input means comprises directional means for selecting a direction and selection means for selecting an input.

44. The method of claim 34, wherein the input means comprises means for scrolling through a list of available inputs and means for selecting one of the available inputs.

45. The method of claim 34, wherein (A) comprises:
(A)(1) providing to the device a first instruction to scroll through a list of a plurality of categories;
(A)(2) visually scrolling through the list of the plurality of categories in response to the first instruction to arrive at a current category; and
(A)(3) providing to the device an instruction to select the current category as the first category.

46. A method comprising:
(A) receiving, from a wireless communication device over a wireless network, a message including:
a first graphical language element, selected by a user of the wireless communication device using an input means of the device, in a first category selected by the user using the input means; and
a second graphical language element, selected by the user using an input means of the device, in a second category selected by the user using the input means;
wherein the message includes a graphical language element representing a subject and a graphical language element representing an action; and
(B) relaying the message over the wireless network.
